(19) United States
(12) Patent Application Publication
(10) Pub. No.: US 2006/0093104 A1
(43) Pub. Date: May 4, 2006

(54) Telephone adapter with advanced features

(75) Inventors: Benjamin Maytal, Mevaseret Zion (IL); Avi Avrahami, Kochav-Yair (IL)

Correspondence Address: WELSH & KATZ, LTD, 120 S RIVERSIDE PLAZA, 22ND FLOOR, CHICAGO, IL, 60606, US

(73) Assignee: SMARTLINK LTD., Netanya (IL)

(21) Appl. No.: 11/243,135

(22) Filed: Oct. 4, 2005

Related U.S. Application Data
(60) Provisional application No. 60/615,948, filed on Oct. 6, 2004.

(51) Int. Cl. H04M 11/00; H04L 12/66

(52) U.S. Cl. 379/93.28; 370/352

(57) ABSTRACT

Communication apparatus includes a telephone adapter, which includes a phone connector, for connecting to a telephone, and a line connector, for connecting to a telephone line of a circuit-switched telephone network, and a computer interface. A phone analog front end (AFE) is coupled to the phone connector and operative to convert audio input signals generated by the telephone into digital output samples for transfer via the computer interface. A line AFE is coupled to the line connector and operative to convert digital input samples received from the computer interface into analog output signals for transmission over the telephone line. A computer, is coupled to the telephone adapter via the computer interface and is arranged to process the digital output samples and to generate the digital input samples.

### CROSS-REFERENCE TO RELATED APPLICATIONS

This application claims the benefit of U.S. Provisional Patent Application 60/615,948, filed Oct. 6, 2004. This application is also related to a U.S. patent application entitled “|Multi-Function Telephone Adapter|,” filed Aug. 25, 2005. Both of these related applications are assigned to the assignee of the present patent application, and their disclosures are incorporated herein by reference.

### FIELD OF THE INVENTION

The present invention relates generally to computer-integrated telephony, and specifically to methods and devices for integrating packet-switched and circuit-switched telephone equipment and services.

### BACKGROUND OF THE INVENTION

Analog telephone adapters are devices that convert the analog signals from a conventional telephone into a format acceptable for transmission over an Internet connection, and vice versa at the receiving end. A variety of products of this sort are available on the market. Examples include the HandyTone series, produced by Grandstream Networks; Sipura Phone Adapters, produced by Sipura Technology, Inc. (recently acquired by Cisco Systems); Quadro® Voice Routers, produced by Epygi® Technologies, Ltd.; FXS VoIP Gateway, produced by Micronet®; Messenger Call Box, produced by BAFO Inc.; Actiontec® Internet Phone Wizard, produced by Actiontec Electronics, Inc.; and M3 Motorola® Messenger Modem, produced by Motorola, Inc.

Various types and features of analog telephone adapters are described in the patent literature. For example, U.S. Pat. No. 6,700,956, whose disclosure is incorporated herein by reference, describes apparatus for selectively connecting a telephone to a telephone network or to the Internet. The apparatus comprises a hardware module and associated software for coupling a personal computer or Internet appliance and a standard analog telephone. The apparatus permits the analog telephone to be toggled between an Internet-based telephone mode and a public switched telephone network (PSTN) mode by inputting a predetermined sequence of dual-tone multi-frequency (DTMF) digits.

U.S. Pat. No. 6,731,751, whose disclosure is incorporated herein by reference, describes interface apparatus, which is interposed between a cordless telephone base unit and a personal computer sound card. The interface emulates a central office connection with respect to the telephone and a microphone and speaker connection with respect to the computer sound card.

U.S. Pat. No. 6,711,160, whose disclosure is incorporated herein by reference, describes an interface unit between a telephone and a packet network. The unit also functions as a gateway between a packet network and a public switched telephone network (PSTN). When power is not supplied to the unit, a fallback switch automatically links the telephone instrument directly to the PSTN, bypassing the circuitry in the unit. The unit also includes an LCD driver and a display for showing information such as caller identification.

### SUMMARY OF THE INVENTION

In disclosed embodiments of the present invention, a telephone adapter couples a computer to an analog telephone and to a circuit-switched telephone network line, such as a PSTN line. The user may dial outgoing calls to the switched telephone network using the analog telephone in the usual manner, or may alternatively direct outgoing calls via the computer to a packet network, such as the Internet. The computer directs incoming calls on the packet network to the analog telephone after first checking that the analog telephone is on hook.

In some embodiments of the present invention, the telephone adapter comprises two analog front ends (AFEs): one connecting to the analog telephone, and the other to the circuit-switched telephone network. Both of the AFEs transmit and receive digital samples to and from the computer. This arrangement facilitates novel user interface functions, by permitting the computer to interact with the analog telephone and to control the user interface functions (such as ring and built-in display) of the telephone. For example, the computer may detect ringing and caller ID signals on the telephone network line, even when the telephone is in use on a VoIP call, and may then notify the user of the incoming PSTN call. Furthermore, the computer may transcode different types of caller ID signals between the switched telephone network and the packet network, and may cause the transcoded information to be shown on the telephone display, as well as on the computer screen. Additional functions are described hereinbelow.

Although features of the present invention are described herein with reference specifically to the dual-AFE adapter design, some of these features may also be implemented using a telephone adapter with a single AFE, such as that described in the above-mentioned related U.S. patent application entitled “Multi-Function Telephone Adapter,” or using other adapters that are known in the art. Conversely, the features of the telephone adapter described in this related application may likewise be implemented using the dual-AFE design described herein.

There is therefore provided, in accordance with an embodiment of the present invention, communication apparatus, including:
a telephone adapter, including:
a phone connector, for connecting to a telephone;
a line connector, for connecting to a telephone line of a circuit-switched telephone network;
a computer interface;
a phone analog front end (AFE), coupled to the phone connector and operative to convert audio input signals generated by the telephone into digital output samples for transfer via the computer interface; and
a line AFE, coupled to the line connector and operative to convert digital input samples received from the computer interface into analog output signals for transmission over the telephone line; and

a computer, which is coupled to the telephone adapter via the computer interface and is arranged to process the digital output samples in order to decode an indication of a destination telephone number that was input to the telephone by a user, and is further arranged to generate the digital input samples responsively to the decoded indication so as to cause the line AFE to transmit over the telephone line a sequence of dual-tone multi-frequency (DTMF) signals corresponding to the destination telephone number.

In one embodiment, the audio input signals include a first series of DTMF tones that are generated by the telephone responsively to user keystrokes, and the digital input samples generated by the computer cause the line AFE to transmit a second series of DTMF tones, which is different from the first series.

In another embodiment, the audio input signals include a voice signal spoken into the telephone by the user, and the computer is adapted to decode the voice signal in order to identify the destination telephone number.

Optionally, the apparatus includes a digital fallback link between the phone AFE and the line AFE, for conveying the digital output samples to the line AFE.

In some embodiments, the computer is further coupled to communicate over a packet network, and is operative to control the telephone adapter so that the telephone serves as an audio input/output (I/O) device in a Voice over Internet Protocol (VoIP) call placed via the computer over the packet network. Typically, the computer is operative to process the digital output samples so as to determine a destination address on the packet network indicated by the input to the telephone by the user, and to place the VoIP call to the destination address.

There is also provided, in accordance with an embodiment of the present invention, communication apparatus, including:

a telephone adapter, including:
a phone connector, for connecting to a telephone;
a line connector, for connecting to a telephone line of a circuit-switched telephone network;
a computer interface;
a line analog front end (AFE), coupled to the line connector and operative to convert telephone input signals received from the telephone line into digital output samples for transfer via the computer interface; and
a phone AFE, coupled to the phone connector and operative to convert a digital input received from the computer interface into analog output signals for output to the telephone; and

a computer, which is coupled to the telephone adapter via the computer interface and is arranged to process the digital output samples in order to detect a ring signal of an incoming call received from the telephone line, and to generate the digital input, responsively to the ring signal, so that the analog output signals cause the telephone to provide an indication of the incoming call to a user.

In a disclosed embodiment, the computer is adapted to vary the digital input so that the analog output signals cause the telephone to ring in a plurality of different ring patterns, which are selected by the computer responsively to a characteristic of the incoming call.

In some embodiments, the computer is further coupled to communicate over a packet network, and is operative to control the telephone adapter so that the telephone serves as an audio input/output (I/O) device in a Voice over Internet Protocol (VoIP) call placed via the computer over the packet network, and so as to cause the telephone to provide the indication to the user upon receipt of an incoming VoIP call from the packet network.

There is additionally provided, in accordance with an embodiment of the present invention, communication apparatus, including:

a telephone adapter, including:
a phone connector, for connecting to a telephone;
a line connector, for connecting to a telephone line of a circuit-switched telephone network;
a computer interface; and
processing circuitry, coupled between the phone connector, the line connector and the computer interface, for converting digital input samples received from the computer interface into analog output signals for output to the phone connector and the line connector, and for converting analog input signals from the phone connector and the line connector to digital output samples for transfer via the computer interface; and

a computer, which is coupled to communicate over a packet network and is operative to control the telephone adapter so that the telephone serves as an audio input/output (I/O) device in a Voice over Internet Protocol (VoIP) call placed to the computer over the packet network, and which is further operative to generate the digital input samples so as to cause the telephone to display a caller identification (CID) responsively to incoming calls received over the packet network and the circuit-switched telephone network.

Typically, the computer is operative to generate the digital input samples so that the analog output signals generated by the processing circuitry are modulated so as to convey at least one of a type 1 CID signal and a type 2 CID signal to the telephone. In one embodiment, the processing circuitry is adapted to provide to the computer an indication of a hook state of the telephone, and wherein the computer is operative to generate the digital input samples so that the analog output signals convey the type 1 CID signal when the telephone is on hook and the type 2 CID signal when the telephone is off hook. Additionally or alternatively, the computer is adapted to decode a packet received from a terminal originating the VoIP call on the packet network so as to determine a user identification associated with the terminal, and to generate the digital input samples so that the at least one of the type 1 CID signal and the type 2 CID signal is indicative of the user identification.

In a disclosed embodiment, the computer is adapted to process the digital output samples so as detect a ring signal with a type 1 CID signal responsively to an incoming telephone call received on the telephone line while the telephone is in use in a VoIP call, to decode the type 1 CID signal so as to extract an identification of the incoming telephone call, and to generate the digital input samples so that the analog output signals generated by the processing circuitry are modulated so as to convey to the telephone a type 2 CID signal that is indicative of the identification.

Additionally or alternatively, the computer is adapted to process the digital output samples so as to detect a ring signal with a CID signal responsively to an incoming telephone call received on the telephone line from an originating telephone, to decode the CID signal so as to determine a user identification associated with the originating telephone, to transmit one or more packets over the packet network responsively to the incoming telephone call so as to set up an outgoing VoIP call between the computer and a destination terminal on the packet network, such that at least one of the packets includes the user identification, and to connect the incoming telephone call with the outgoing VoIP call via the telephone adapter so that the originating telephone communicates with the destination terminal.

There is further provided, in accordance with an embodiment of the present invention, a method for communication, including:

connecting a telephone adapter, which includes a phone analog front end (AFE) and a line AFE, to a telephone, to a telephone line of a circuit-switched telephone network, and to a computer, so that the phone AFE converts audio input signals generated by the telephone into digital output samples for transfer to the computer, and the line AFE converts digital input samples received from the computer into analog output signals for transmission over the telephone line;

processing the digital output samples using the computer in order to decode an indication of a destination telephone number that was input to the telephone by a user; and

generating the digital input samples using the computer, responsively to the decoded indication, so as to cause the line AFE to transmit over the telephone line a sequence of dual-tone multi-frequency (DTMF) signals corresponding to the destination telephone number.

There is moreover provided, in accordance with an embodiment of the present invention, a method for communication, including:

connecting a telephone adapter, which includes a phone analog front end (AFE) and a line AFE, to a telephone, to a telephone line of a circuit-switched telephone network, and to a computer, so that the line AFE converts telephone input signals received from the telephone line into digital output samples for transfer to the computer, and the phone AFE converts a digital input received from the computer into analog output signals for output to the telephone;

processing the digital output samples using the computer in order to detect a ring signal of an incoming call received from the telephone line; and

generating the digital input, using the computer, responsively to the ring signal, so that the analog output signals cause the telephone to provide an indication of the incoming call to a user.

There is furthermore provided, in accordance with an embodiment of the present invention, a method for communication, including:

connecting a telephone adapter to a telephone, to a telephone line of a circuit-switched telephone network, and to a computer, so as to convert digital input samples received from the computer into analog output signals for output to the telephone and the telephone line, and to convert analog input signals from the telephone and the telephone line to digital output samples for transfer to the computer; and

controlling the telephone adapter, using the computer, so that the telephone serves as an audio input/output (I/O) device in a Voice over Internet Protocol (VoIP) call placed to the computer over the packet network; and

generating the digital input samples, using the computer, so as to cause the telephone to display a caller identification (CID) responsively to incoming calls received over the packet network and the circuit-switched telephone network.

The present invention will be more fully understood from the following detailed description of the embodiments thereof, taken together with the drawings in which:

### BRIEF DESCRIPTION OF THE DRAWINGS

FIG. 1 is a schematic, pictorial illustration of a telephone communication system, in accordance with an embodiment of the present invention;

FIG. 2 is a block diagram that schematically shows details of a telephone adapter, in accordance with an embodiment of the present invention; and

FIG. 3 is a flow chart that schematically illustrates a method for caller ID transcoding, in accordance with an embodiment of the present invention.

### DETAILED DESCRIPTION OF EMBODIMENTS

System Overview

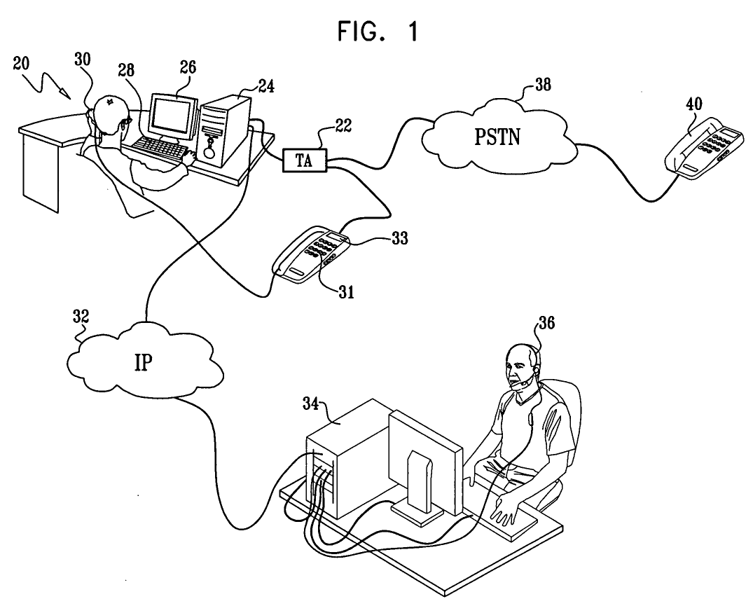

FIG. 1 is a schematic, pictorial illustration of a telephone communication system 20, in accordance with an embodiment of the present invention. System 20 combines conventional analog and packet-switched telephone network components using a telephone adapter (TA) 22, to provide a novel set of features and functions, which are described hereinbelow.

Adapter 22 is used in conjunction with a computer 24, typically a personal computer (PC), which comprises a user interface including a display 26 and one or more input devices 28, such as a keyboard or mouse. (Alternatively, computer 24 may comprise any other sort of suitable computing device having a CPU; and computer 24 is referred to hereinbelow as a PC solely by way of example, and not limitation.) Adapter 22 may connect to the PC through a suitable digital input/output (I/O) port, such as a Universal Serial Bus (USB) port or High-Definition Audio (HD-Audio) port, or through a local area network (LAN). Alternatively, the adapter may be configured as a plug-in card or chip set, which may be housed inside computer 24.

Adapter 22 also communicates with an analog telephone 30 and with a circuit-switched telephone network 38. Typically, network 38 is a PSTN, and adapter 22 connects to the PSTN and to telephone 30 via suitable cables. Alternatively, telephone 30 may communicate over the air with adapter 22 via a cordless connection. Further alternatively, telephone 30 and adapter 22 may be integrated into a single device. Further alternatively or additionally, network 38 may comprise another type of circuit-switched telephone network, such as a cellular network. Adapter 22 is configured, as described hereinbelow, to permit users to place and receive telephone calls using telephone 30 via network 38 to and from other analog telephones 40. For clarity in the description that follows, such calls will be referred to as “PSTN calls,” but it will be understood that calls on other types of circuit-switched networks may be handled in similar fashion.

Telephone 30 comprises user interface components, which include a keypad 31 and a speaker (not shown) for producing a ring tone, and which may optionally include a display 33. The telephone may be configured to receive and display caller identification (CID) information on display 33. CID transmission and detection are well known in the art of telephone communications. In “type 1” CID transmission, the CID of the telephone initiating a call is encoded between rings of the ring signal transmitted from the central office to the telephone that is to receive the call. If the receiving telephone is configured for CID detection, it decodes and displays the initiating CID (or a corresponding text string), on display 33, for example. In “type 2” CID transmission, the CID of the initiating telephone is encoded together with a “call waiting” signal that is transmitted when the receiving telephone is off-hook. The type 1 and type 2 CID protocols are defined in detail, for example, in TIA Standard TIA-777-A, promulgated by the Telecommunications Industry Association (May, 2003), and incorporated herein by reference.

Computer 24 is also connected to a packet-switched network 32, such as the Internet, via a suitable modem (not shown). Typically, in order to enable high-quality Voice over IP (VoIP) service, the connection to network 32 is a broadband connection, such as a DSL, cable modem or ISDN connection. Alternatively, an analog modem connection, such as a V.90 or V.92 modem connection, may be adequate for some VoIP applications. The user of computer 24 is then able to use telephone 30, via adapter 22, as an I/O device for placing and receiving VoIP calls via network 32 to and from other VoIP-enabled terminals, such as a computer 34 that is equipped with suitable VoIP software and audio interface equipment 36 or with a telephone adapter such as adapter 22, as well as with non-PC VoIP devices.

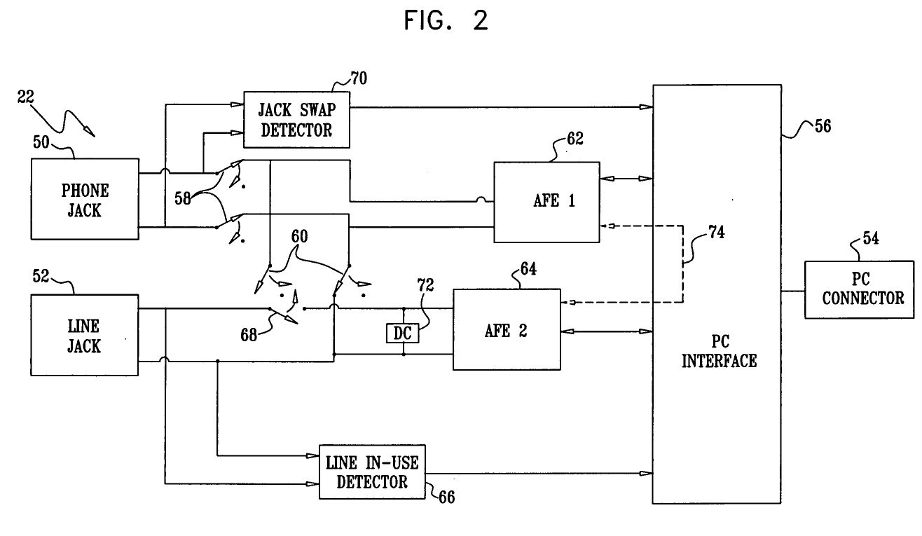

FIG. 2 is a block diagram that schematically shows details of telephone adapter 22, in accordance with an embodiment of the present invention. For the sake of conceptual clarity in the explanation that follows, adapter 22 is shown as comprising certain functional blocks. Not all of these blocks are essential to all aspects of operation of the adapter, as will be apparent from the explanation. Furthermore, in practical implementations, some of these blocks may be combined into a single physical element, such as an integrated circuit chip. Alternatively or additionally, certain blocks may be made up of multiple discrete components. Various alternative implementations of the circuitry in adapter 22 will be apparent to those skilled in the art; and all such implementations are considered to be within the scope of the present invention.

Adapter 22 comprises a phone jack 50, for connecting to telephone 30, and a line jack 52, for connecting to network 38. Typically, jacks. 50 and 52 comprise standard cable connectors, such as RJ-11 receptacles.

On the PC side, adapter 22 comprises a PC connector 54, which is coupled to the other elements of the adapter via a PC interface 56. As noted above, connector 54 may comprise a USB connector, in which case PC interface 56 comprises interface hardware and I/O logic for multiplexing digital input and output data to and from the elements of adapter 22 over the USB link. Alternatively, connector 54 may comprise a LAN connector, in which case PC interface 56 comprises suitable LAN interface circuits. Further alternatively, for embodiments in which adapter 22 is housed inside computer 24, connector 54 may comprise a PC bus connector, such as a Peripheral Component Interface (PCI) bus connector or an Intel® High Definition (HD) Audio connection, with suitable bus interface logic in PC interface 56. Further additionally or alternatively, adapter 22 may comprise two or more separate PC interface circuits and connectors, each serving a different function and/or connecting a different part of the adapter to the PC. The circuits in adapter 22 may draw power from computer 24, if the computer is configured to provide power via connector 54, or the circuits may alternatively be powered by a battery or other power supply (not shown) in adapter 22.

Adapter 22 comprises switches 58 and 60, which are controlled by computer 24 via interface 56 in order to determine the operational mode of the adapter. In the setting shown in FIG. 2, switches 58 and 60 couple telephone 30 directly to network 38 via jacks 50 and 52, so that the user can place and receive ordinary analog telephone calls in the usual manner without involvement of the computer. As long as the telephone is on hook, and the switches are in this position, incoming calls from network 38 will cause the telephone to ring normally.

Since jacks 50 and 52 may be outwardly identical, it is possible that a user of adapter 22 will accidentally reverse the telephone and line connections. Such a reversal might damage the components of adapter 22 and could violate safety requirements. Therefore, adapter 22 comprises a jack swap detector 70 for detecting and alerting the user to possible reversal of the connections. During operation of the jack swap detector, computer 24 flips switches 58 to the lower position shown in FIG. 2. Further details of the jack swap detection function are described in the above-mentioned patent application entitled “Multi-Function Telephone Adapter.”

Adapter 22 comprises processing circuitry for purposes of digital services and interaction with computer 24. In the embodiment shown in FIG. 2, the processing circuitry comprises dual analog front ends (AFEs) 62 and 64, which respectively couple telephone 30 and line jack 52 to computer 24 by way of interface 56. AFEs 62 and 64 typically comprise analog/digital (A/D) and digital/analog (D/A) converters. AFE 62 also comprises a subscriber line interface circuit (SLIC) for connection to telephone 30, and thus performs the added functions of ring generation, off-hook detection, and providing DC power to telephone 30. AFE 64 comprises a data access arrangement (DAA), as is required for connection of computer 24 to telephone network 38. These standard AFE components are well known in the art and are omitted from the figures for the sake of simplicity.

In one embodiment, line jack 52, AFE 64, and certain associated circuits used in adapter 22 are part of an existing voice-band modem, which may be pre-installed in computer 24. In this case, the functionality of adapter 22 is achieved by the addition of an accessory comprising phone jack 50, AFE 62, and other associated components, together with suitable software running on the PC. The adapter in this embodiment has nearly all the features of the integrated adapter described herein, with the possible exception of the analog link provided by switches 60 and a digital fallback link 74, which is described hereinbelow. Because this embodiment takes advantage of the existing modem, the added component cost and size of the adapter are reduced, in comparison with the integrated adapter. References to the telephone adapter in the specification and claims of this application should be understood to include embodiments that make use of a separate voice-band modem in this manner, unless specified otherwise.

In the position of switches 58 that is shown in FIG. 2, AFE 62 samples and digitizes analog audio signals from telephone 30 for output to computer 24 and converts digital audio samples from computer 24 to analog audio signals for input to telephone 30. The functionality of AFE 62 permits telephone 30 to be used as the audio input/output device in VoIP calls placed from or to computer 24 over network 32. In addition, AFE 62 enables computer 24 to determine the hook state of telephone 30 and to receive audio control signals generated by telephone 30, such as DTMF tones generated when the user presses telephone keys, as well as voice input from the user. In the reverse direction, AFE 62 may be operated by the computer to convey signals to telephone 30, such as ring, call waiting, and caller ID signals. Some examples of these functions are described hereinbelow.

In general, for computer-controlled operation of adapter 22, computer 24 moves switches 60 to the right-hand position in FIG. 2. In this position, the telephone is disconnected from the telephone line, and all signals to and from the telephone pass through AFE 62. The telephone may then be used in placing or receiving VoIP calls over network 32. In addition, when computer 24 closes a line switch 68, signals to and from PSTN 38 pass through AFE 64. In this configuration, the telephone may communicate with the PSTN by exchange of digital samples between AFE 62 and AFE 64 via computer 24.

Typically, the samples pass through computer 24 via PC interface 56, and the computer is thus able to perform various call control and enhancement functions, some of which are described hereinbelow.

Optionally, AFE 62 may be connected to AFE 64 by an auxiliary digital link 74, whereby the digital samples pass directly between the AFEs without passing through the computer. This sort of link is useful particularly for maintaining telephone service when computer 24 is shut off or on standby, in embodiments in which switches 60 are not available to connect jacks 50 and 52 directly. Use of this auxiliary digital link requires that adapter 22 receive electrical power, either from computer 24 or from another source, even when the computer is not fully operational.

AFE 64 may be operated by computer 24 to perform line sensing functions that require the use of dedicated electronic hardware elements in systems known in the art. For example, when switch 68 is closed, AFE 64 digitizes ring signals, call waiting signals, and CID (type 1 and type 2) signals that are received over the telephone line. Computer 24 analyzes the digitized samples from AFE 64 in order to detect incoming calls and to decode the CID of the calling party. The computer then provides notification to the user, or performs other functions such as automatic call forwarding, as described further hereinbelow. The configuration of adapter 22 permits the computer to perform these functions regardless of whether telephone 30 is on or off hook (during a PSTN call or a VoIP call, for example).

The computer may also analyze the voltage level indicated by the digitized samples from AFE 64 in order to determine whether a telephone line is connected to the line jack. If no line connection is detected, the computer notifies the user of the error and may disable line-related functions of adapter 22. Telephone 30 may still be used under these conditions in placing and receiving VoIP calls.

To facilitate implementation of advanced control functions by computer 24, adapter 22 may comprise a line use detector 66. The line use detector senses the DC voltage level on the telephone line, and thus indicates to the computer when there is a PSTN call in progress via adapter 22 or via any other telephone connected to the same line on network 38. (In the absence of any voltage on the line, detector 66 senses no voltage and may indicate to computer 24 that there is no active telephone line connected to line jack 52.) When switch 68 is open, an optional CID bypass circuit 69 may be used to pass AC-coupled signals, generated on the telephone line, such as ring and type 1 CID signals, from the telephone line to AFE 64 for conversion into digital samples.

In addition, when switches 60 are in the right-hand position, and switch 68 is closed, a DC hold circuit 72 is switched across line jack 52 so that adapter 22 draws current from the central office of network 38 independently of telephone 30. This feature enables computer 24 to keep a call open on network 38 regardless of whether telephone 30 is in use for the call or for another purpose, such as when the user wishes to keep a call with telephone 40 on hold while using telephone 30 to place or receive a VoIP call. Optionally, computer 24 may use AFE 64 for modem service (such as fax or data modem service) via PSTN 38, under control of “soft modem” software running on the computer, as described in the above-mentioned related patent application. This modem service can be maintained even while telephone 30 and the computer's high-speed modem are in use on a VoIP call.

Advanced user Interface Features

The use of dual AFEs 62 and 64 in adapter 22 permits computer 24 to control various user interface functions of telephone 30, and thus provide a unified, digitally-controlled interface for both PSTN and VoIP calls. The user interface functions may in some cases be augmented by display 26 and input device 28 of the computer. Some exemplary functions are described hereinbelow:

Computer-Mediated Dialing

When switches 60 (FIG. 2) are in the right-hand position, and the user presses keys on keypad 31, the DTMF tones generated by telephone 30 do not reach PSTN 38 directly, but rather are digitized by AFE 62. Computer 24 receives and processes the digital samples generated by the AFE and thus decodes the numbers that the user has dialed. The computer analyzes the string of numbers in order to determine whether to place the call through PSTN 38 or through packet network 32. The choice of network may be user selected (by dialing an appropriate code to invoke a VoIP connection, for example), or may be selected automatically by the computer based on pre-programmed selection rules.

Upon determining that a given call is to be placed over PSTN 38, computer 24 instructs adapter 22 to close switch 68 and transmits a sequence of digital samples to AFE 64, corresponding to the DTMF tones that must be generated in order to dial the desired telephone number. The computer may wait to generate the DTMF dialing sequence until the user has finished pressing the complete keypad sequence. This feature permits the user to dial the entire number, check that the number is correct (by observing display 33, for example), and only then indicate to the computer that the number should be dialed, typically by entering another keystroke, such as the “#” key. Computer-aided speed dialing may also be provided in this manner.

As another option, the user may speak into telephone 30 in order to cause the computer to dial a call. In this case, AFE 62 digitizes the user's voice signal, and the computer analyzes the digitized voice signal in order to decode the telephone number or name of the person to be called.

Software-Controlled Ring Detection and Generation

As noted above, computer 24 detects ring signals coming into adapter 22 from PSTN 38 by processing the digital samples that are output by AFE 64 (based on the analog signals conveyed by CID circuit 69). The computer also determines whether telephone 30 is on or off hook by processing signals that are output by AFE 62. Upon detecting a ring voltage on line jack 52 while the telephone is on hook, computer 24 generates a ring output to AFE 62, which causes the AFE to produce an analog ring input to telephone 30. The ring signal generated in this manner is independent of the ring voltage on the telephone line. The computer may similarly generate a ring output to the telephone adapter upon receiving an incoming VoIP call.

The ring patterns that are generated by the computer for incoming PSTN and VoIP calls may be identical, or they may alternatively be different in order to give the user an audible cue as to the type of call that is coming in. Similarly, the computer may generate different ring patterns depending on the identity of the party originating the call. For this purpose, the computer decodes the CID that is encoded in the incoming PSTN call or a comparable user ID field in the packets initiating the VoIP call (such as the host name or IP address in the Call-ID specified in Session Initiation Protocol packets). The computer compares the decoded value to a look-up table or other logic that indicates the type of ring to be generated in each case.

Computer 24 may also superimpose a brief tone on the digital audio samples that it outputs to AFE 62 during a call in order to indicate to the user that another call is waiting. This functionality may be invoked (at the user's option) whenever the telephone is off hook, regardless of whether the user is currently on a PSTN call or a VoIP call. It may be used to indicate to the user that either a PSTN or a VoIP call is waiting. The computer may vary the call waiting tone depending on the type of call and identity of the calling party, just as it may generate different ring types, as described above. The computer may also generate a CID signal, so that the telephone presents a call-waiting indication and the identity of the calling party on display 33, as described hereinbelow. Additionally or alternatively, the computer may present a call-waiting message on display 26 in conjunction with the call-waiting tone and/or other indication transmitted via telephone 30 (or without such a call-waiting tone or indication).

Packet Telephony Gateway

Computer 24 may serve, in conjunction with adapter 22, as a gateway for placing telephone calls between PSTN 38 and packet network 32. For example, a VoIP user, such as the user of computer 34, may place a call to telephone 40 by sending an appropriate packet message to computer 24, indicating the telephone number of telephone 40. Computer 24 sets up a VoIP call to computer 34, places a PSTN call to telephone 40, and then connects the two calls together via adapter 22. A similar method may be used to place calls from the packet network into a private branch exchange (PBX) or other circuit-switched telephone network. VoIP users may thus avoid or reduce long-distance telephone charges when they are traveling, for example.

In a similar fashion, users of PSTN telephones, such as telephone 40, may place VoIP calls by dialing in to computer 24, and then pressing an appropriate key sequence to indicate to the computer the destination of the desired VoIP call.

The gateway functionality of system 20 may also be used for teleconferencing and call forwarding. In the teleconference mode, a user of the system may place or receive PSTN and VoIP calls simultaneously. Computer 24 mixes the digital audio samples from both calls and outputs the mixed sample streams to both AFE 62 and AFE 64, as well as in VoIP packets transmitted over network 32. In call forwarding mode, the user of system 20 may instruct computer 24 to automatically pick up and forward PSTN calls to a specified VoIP address, or to pick up and forward VoIP calls to a specified PSTN telephone number.

The gateway functions of system 20 generally do not require any user to be present at the site of computer 24 or to be involved in local operation of the computer. Despite the convenience of such unattended operation, however, it leaves the system open to abuse by hackers, who may attempt to place telephone calls through computer 24 at the expense of the (absent) computer user. To prevent unauthorized use, computer 24 may detect and verify the identity of the remote party requesting the call before actually placing the call. For example, the computer may detect the CID encoded in calls received from PSTN 38 or the equivalent ID field in packets received from network 32. The computer checks the ID value against a list of authorized IDs, and places the call only if the ID appears on the authorized list.

CID Transcoding

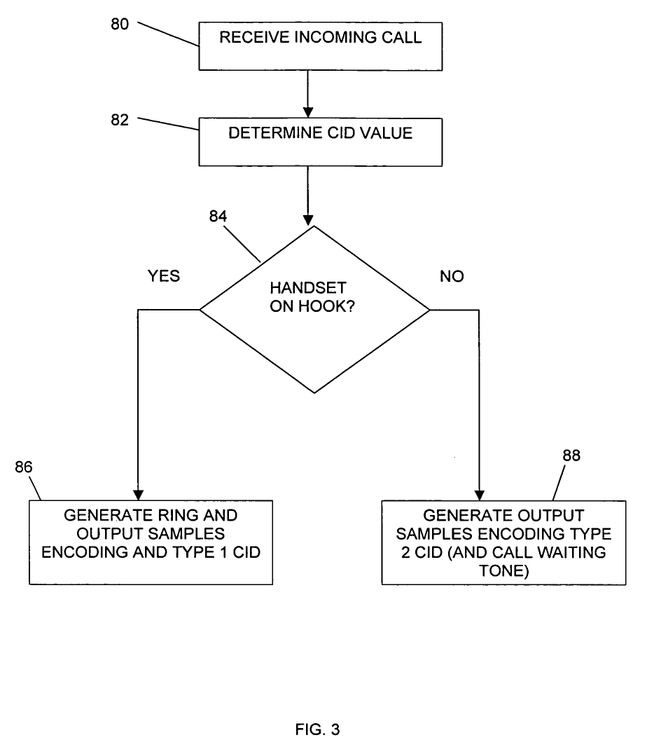

FIG. 3 is a flow chart that schematically illustrates a method for CID transcoding, in accordance with an embodiment of the present invention. This method is used in generating an analog CID signal for output to telephone 30, in response to both analog telephone calls incoming from PSTN 38 and VoIP calls from packet network 32.

The method is initiated when computer 24 receives an incoming call, at a call reception step 80. Computer 24 determines a CID value to associate with the call, at a CID determination step 82. For this purpose, as noted earlier, when adapter 22 receives an incoming call from PSTN 38, AFE 64 digitizes the encoded CID signal (type 1 or type 2), and computer 24 analyzes the digital samples in order to decode the CID. For VoIP calls, the computer decodes the user ID field from incoming VoIP packets and chooses a corresponding CID value for output to telephone 30 via adapter 22.

Having determined a CID value that is to be output to telephone 30 in response to an incoming call, computer 24 ascertains whether telephone 30 is on-hook or off-hook, at a hook state determination step 84. The computer then generates an appropriate sequence of digital samples encoding the CID value for output to adapter 22 depending on the telephone hook state. If the telephone is on hook, computer 24 generates the samples so as to encode and modulate the CID value as a type 1 CID, at a type 1 generation step 86. In this case, the computer outputs the CID samples and ring instructions via interface 56 to AFE 62 so as to cause the AFE to generate the analog CID signal between the first and second ring signals that it transmits to telephone 30. In response to these analog signals, the telephone rings and displays the CID value on display 33.

If the telephone is off hook, computer 24 generates the digital output samples so as to encode the CID value as a type 2 CID, at a type 2 generation step 88. Typically, telephone 30 will be off hook in the course of a telephone call (over either the PSTN or packet network). During the call, as described above, incoming audio signals from the network are conveyed by computer 24 in the form of digital samples to AFE 62, which converts the digital samples to analog audio signals for output to telephone 30. At step 88, the computer interleaves the digital output samples that encode the CID type 2 alerting tone into the digital samples encoding the audio signals, and waits for telephone 30 to respond with CID type 2 acknowledge tone, in accordance with the applicable standard. If telephone 30 responds in time, the computer generates the digital samples that encode the type 2 CID value so that the CID value is inserted in the proper form into the analog signal that is output to telephone 30. Telephone 30 decodes the type 2 CID value and displays the value on display 33.

The signals output by adapter 22 at both of steps 86 and 88 are conventional analog signals, complying with PSTN standards. Therefore, the CID transcoding function of system 20 may be used in conjunction with any telephone having CID display capability. No modification is required to the telephone. (Of course, if the telephone does not have CID display capability, it will simply ignore the transcoded CID value, just as it will ignore any conventional CID signal.) The type 2 CID may be generated and displayed by the telephone regardless of whether the telephone is off-hook on a PSTN call or a VoIP call.

Exemplary uses of the CID transcoding functions of system 20 include:
Transcoding VoIP user ID to PSTN CID. As noted earlier, when a caller on packet network 32 (for example, the user of computer 34) places a VoIP call to computer 24, the packets transmitted by computer 34 contain a user ID field. Based on the value in this field, computer 24 determines an equivalent PSTN CID value and generates appropriate digital output samples to adapter 22.
Transcoding type 1 CID to type 2 CID. When telephone 30 is off-hook on a VoIP call, the telephone line to PSTN 38 is typically idle, i.e., it appears to the PSTN central office that the customer premises equipment is on hook. Therefore, when telephone 40, for example, places a call to the user of system 20, the central office generates a ring signal on the telephone line, with the type 1 CID interleaved between the first and second rings. Computer 24 processes the digital samples that are output by AFE 64 and thus senses and decodes the ring signal and CID. The computer then transcodes the type 1 CID to type 2 (at step 88) for output via AFE 62 to telephone 30 and presentation of the CID on display 33. If the user of the telephone then signals that he or she wishes to take the waiting call (by momentarily depressing the hook switch on the telephone, for example, or by some other keystroke), the computer connects the waiting call to the telephone.

Computer 24 may also perform transcoding of PSTN CID to VoIP user ID. This feature is useful, for example when system 20 is used as a packet telephony gateway, as described above. When the user of telephone 40 dials into system 20 in order to place a VoIP call, the incoming call signal received from the telephone line includes the CID of telephone 40. Computer 24 decodes the CID and then inserts a corresponding value (such as a VoIP user ID or name) into the VoIP call setup packets that it transmits over network 32. The user of computer 34 will then receive a message indicating that a VoIP call is coming in from this user.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Communication apparatus, comprising:
a telephone adapter, comprising:
a phone connector, for connecting to a telephone;
a line connector, for connecting to a telephone line of a circuit-switched telephone network;
a computer interface;
a phone analog front end (AFE), coupled to the phone connector and operative to convert audio input signals generated by the telephone into digital output samples for transfer via the computer interface; and
a line AFE, coupled to the line connector and operative to convert digital input samples received from the computer interface into analog output signals for transmission over the telephone line; and
a computer, which is coupled to the telephone adapter via the computer interface and is arranged to process the digital output samples in order to decode an indication of a destination telephone number that was input to the telephone by a user, and is further arranged to generate the digital input samples responsively to the decoded indication so as to cause the line AFE to transmit over the telephone line a sequence of dual-tone multi-frequency (DTMF) signals corresponding to the destination telephone number.

2. The apparatus according to claim 1, wherein the audio input signals comprise a first series of DTMF tones that are generated by the telephone responsively to user keystrokes, and wherein the digital input samples generated by the computer cause the line AFE to transmit a second series of DTMF tones, which is different from the first series.

3. The apparatus according to claim 1, wherein the audio input signals comprise a voice signal spoken into the telephone by the user, and wherein the computer is adapted to decode the voice signal in order to identify the destination telephone number.

4. The apparatus according to claim 1, and comprising a digital fallback link between the phone AFE and the line AFE, for conveying the digital output samples to the line AFE.

5. The apparatus according to claim 1, wherein the line AFE is further operative to convert analog line signals received from the telephone line into digital line samples for transfer via the computer interface, and the phone AFE is operative to convert digital phone samples received from the computer interface into telephone output signals for transmission to the telephone, and
wherein the computer is operative to process the digital line samples so as to detect at least one of a ring signal and a caller identification (CID) signal of an incoming call received from the telephone line, and to generate the digital phone samples, responsively to the at least one of the ring signal and the CID signal, so that the telephone output signals cause the telephone to provide an indication of the incoming call to the user.

6. The apparatus according to claim 1, wherein the computer is further coupled to communicate over a packet network, and is operative to control the telephone adapter so that the telephone serves as an audio input/output (I/O) device in a Voice over Internet Protocol (VoIP) call placed via the computer over the packet network.

7. The apparatus according to claim 6, wherein the computer is operative to process the digital output samples so as to determine a destination address on the packet network indicated by the input to the telephone by the user, and to place the VoIP call to the destination address.

8. Communication apparatus, comprising:
a telephone adapter, comprising:
a phone connector, for connecting to a telephone;
a line connector, for connecting to a telephone line of a circuit-switched telephone network;
a computer interface;
a line analog front end (AFE), coupled to the line connector and operative to convert telephone input signals received from the telephone line into digital output samples for transfer via the computer interface; and
a phone AFE, coupled to the phone connector and operative to convert a digital input received from the computer interface into analog output signals for output to the telephone; and
a computer, which is coupled to the telephone adapter via the computer interface and is arranged to process the digital output samples in order to detect a ring signal of an incoming call received from the telephone line, and to generate the digital input, responsively to the ring signal, so that the analog output signals cause the telephone to provide an indication of the incoming call to a user.

9. The apparatus according to claim 8, wherein the computer is adapted to vary the digital input so that the analog output signals cause the telephone to ring in a plurality of different ring patterns, which are selected by the computer responsively to a characteristic of the incoming call.

10. The apparatus according to claim 8, wherein the computer is further coupled to communicate over a packet network, and is operative to control the telephone adapter so that the telephone serves as an audio input/output (I/O) device in a Voice over Internet Protocol (VoIP) call placed via the computer over the packet network, and so as to cause the telephone to provide the indication to the user upon receipt of an incoming VoIP call from the packet network.

11. The apparatus according to claim 8, wherein the computer is operative to process the digital output samples in order to detect a caller identification (CID) in the incoming call, and to generate the digital input so as to cause the telephone to display the CID.

12. Communication apparatus, comprising:
a telephone adapter, comprising:
a phone connector, for connecting to a telephone;
a line connector, for connecting to a telephone line of a circuit-switched telephone network;
a computer interface; and
processing circuitry, coupled between the phone connector, the line connector and the computer interface, for converting digital input samples received from the computer interface into analog output signals for output to the phone connector and the line connector, and for converting analog input signals from the phone connector and the line connector to digital output samples for transfer via the computer interface; and
a computer, which is coupled to communicate over a packet network and is operative to control the telephone adapter so that the telephone serves as an audio input/output (I/O) device in a Voice over Internet Protocol (VoIP) call placed to the computer over the packet network, and which is further operative to generate the digital input samples so as to cause the telephone to display a caller identification (CID) responsively to incoming calls received over the packet network and the circuit-switched telephone network.

13. The apparatus according to claim 12, wherein the computer is operative to generate the digital input samples so that the analog output signals generated by the processing circuitry are modulated so as to convey at least one of a type 1 CID signal and a type 2 CID signal to the telephone.

14. The apparatus according to claim 13, wherein the processing circuitry is adapted to provide to the computer an indication of a hook state of the telephone, and wherein the computer is operative to generate the digital input samples so that the analog output signals convey the type 1 CID signal when the telephone is on hook and the type 2 CID signal when the telephone is off hook.

15. The apparatus according to claim 13, wherein the computer is adapted to decode a packet received from a terminal originating the VoIP call on the packet network so as to determine a user identification associated with the terminal, and to generate the digital input samples so that the at least one of the type 1 CID signal and the type 2 CID signal is indicative of the user identification.

16. The apparatus according to claim 12, wherein the computer is adapted to process the digital output samples so as detect a ring signal with a type 1 CID signal responsively to an incoming telephone call received on the telephone line while the telephone is in use in a VoIP call, to decode the type 1 CID signal so as to extract an identification of the incoming telephone call, and to generate the digital input samples so that the analog output signals generated by the processing circuitry are modulated so as to convey to the telephone a type 2 CID signal that is indicative of the identification.

17. The apparatus according to claim 12, wherein the computer is adapted to process the digital output samples so as to detect a ring signal with a CID signal responsively to an incoming telephone call received on the telephone line from an originating telephone, to decode the CID signal so as to determine a user identification associated with the originating telephone, to transmit one or more packets over the packet network responsively to the incoming telephone call so as to set up an outgoing VoIP call between the computer and a destination terminal on the packet network, such that at least one of the packets comprises the user identification, and to connect the incoming telephone call with the outgoing VoIP call via the telephone adapter so that the originating telephone communicates with the destination terminal.

18. A method for communication, comprising:
connecting a telephone adapter, which comprises a phone analog front end (AFE) and a line AFE, to a telephone, to a telephone line of a circuit-switched telephone network, and to a computer, so that the phone AFE converts audio input signals generated by the telephone into digital output samples for transfer to the computer, and the line AFE converts digital input samples received from the computer into analog output signals for transmission over the telephone line;
processing the digital output samples using the computer in order to decode an indication of a destination telephone number that was input to the telephone by a user; and
generating the digital input samples using the computer, responsively to the decoded indication, so as to cause the line AFE to transmit over the telephone line a sequence of dual-tone multi-frequency (DTMF) signals corresponding to the destination telephone number.

19. The method according to claim 18, wherein the audio input signals comprise a first series of DTMF tones that are generated by the telephone responsively to user keystrokes, and wherein the digital input samples generated by the computer cause the line AFE to transmit a second series of DTMF tones, which is different from the first series.

20. The method according to claim 18, wherein the audio input signals comprise a voice signal spoken into the telephone by the user, and wherein processing the digital output samples comprises decoding the voice signal in order to identify the destination telephone number.

21. The method according to claim 18, wherein the line AFE is further operative to convert analog line signals received from the telephone line into digital line samples for transfer to the computer, and the phone AFE is operative to convert digital phone samples received from the computer interface into telephone output signals for transmission to the telephone, and
wherein the method comprises processing the digital line samples using the computer so as to detect at least one of a ring signal and a caller identification (CID) signal of an incoming call received from the telephone line, and generating the digital phone samples, responsively to the at least one of the ring signal and the CID signal, so that the telephone output signals cause the telephone to provide an indication of the incoming call to the user.

22. The method according to claim 18, wherein the method comprises controlling the telephone adapter, using the computer, so that the telephone serves as an audio input/output (I/O) device in a Voice over Internet Protocol (VoIP) call placed via the computer over a packet network.

23. The method according to claim 22, wherein processing the digital output samples comprises determining a destination address on the packet network indicated by the input to the telephone by the user, and placing the VoIP call to the destination address.

24. A method for communication, comprising:
connecting a telephone adapter, which comprises a phone analog front end (AFE) and a line AFE, to a telephone, to a telephone line of a circuit-switched telephone network, and to a computer, so that the line AFE converts telephone input signals received from the telephone line into digital output samples for transfer to the computer, and the phone AFE converts a digital input received from the computer into analog output signals for output to the telephone;
processing the digital output samples using the computer in order to detect a ring signal of an incoming call received from the telephone line; and
generating the digital input, using the computer, responsively to the ring signal, so that the analog output signals cause the telephone to provide an indication of the incoming call to a user.

25. The method according to claim 24, wherein generating the digital input comprises varying the digital input so that the analog output signals cause the telephone to ring in a plurality of different ring patterns, which are selected by the computer responsively to a characteristic of the incoming call.

26. The method according to claim 24, and comprising controlling the telephone adapter, using the computer, so that the telephone serves as an audio input/output (I/O) device in a Voice over Internet Protocol (VoIP) call placed via the computer over a packet network, and generating the digital input so as to cause the telephone to provide the indication to the user upon receipt of an incoming VoIP call from the packet network.

27. The method according to claim 24, wherein processing the digital output samples comprises detecting a caller identification (CID) in the incoming call, and wherein generating the digital input comprises causing the telephone to display the CID.

28. A method for communication, comprising:
connecting a telephone adapter to a telephone, to a telephone line of a circuit-switched telephone network, and to a computer, so as to convert digital input samples received from the computer into analog output signals for output to the telephone and the telephone line, and to convert analog input signals from the telephone and the telephone line to digital output samples for transfer to the computer; and
controlling the telephone adapter, using the computer, so that the telephone serves as an audio input/output (I/O) device in a Voice over Internet Protocol (VoIP) call placed to the computer over the packet network; and
generating the digital input samples, using the computer, so as to cause the telephone to display a caller identification (CID) responsively to incoming calls received over the packet network and the circuit-switched telephone network.

29. The method according to claim 28, wherein generating the digital input samples comprises creating the digital input samples so that the analog output signals generated by the telephone adapter are modulated so as to convey at least one of a type 1 CID signal and a type 2 CID signal to the telephone.

30. The method according to claim 28, and comprising sensing a hook state of the telephone, wherein generating the digital input samples comprises creating the digital input samples so that the analog output signals convey the type 1 CID signal when the telephone is on hook and the type 2 CID signal when the telephone is off hook.

31. The method according to claim 30, wherein creating the digital input samples comprises decoding a packet received from a terminal originating the VoIP call on the packet network so as to determine a user identification associated with the terminal, and forming the digital input samples so that the at least one of the type 1 CID signal and the type 2 CID signal is indicative of the user identification.

32. The method according to claim 28, wherein generating the digital input samples comprises:
processing the digital output samples so as detect a ring signal with a type 1 CID signal responsively to an incoming telephone call received on the telephone line while the telephone is in use in a VoIP call;
decoding the type 1 CID signal so as to extract an originating telephone number of the incoming telephone call; and
creating the digital input samples so that the analog output signals generated by the processing circuitry are modulated so as to convey to the telephone a type 2 CID signal that is indicative of the originating telephone number.

33. The method according to claim 28, wherein generating the digital input samples comprises:
processing the digital output samples so as detect a ring signal with a CID signal responsively to an incoming telephone call received on the telephone line from an originating telephone;
decoding the CID-signal so as to determine a user identification associated with the originating telephone;
transmitting one or more packets over the packet network responsively to the incoming telephone call so as to set up an outgoing VoIP call between the computer and a destination terminal on the packet network, such that at least one of the packets comprises the user identification; and
connecting the incoming telephone call with the outgoing VoIP call via the telephone adapter so that the originating telephone communicates with the destination terminal.
